(19) United States
(12) Patent Application Publication
(10) Pub. No.: US 2026/0094518 A1
(43) Pub. Date: Apr. 2, 2026

(54) ROAD MONITORING SYSTEM, VEHICLE, ROAD MONITORING DEVICE, AND ROAD MONITORING METHOD

(71) Applicant: NEC Corporation, Tokyo (JP)

(72) Inventors: Tatsuya FUJIMOTO, Tokyo (JP); Junichi ABE, Tokyo (JP); Hidemi NOGUCHI, Tokyo (JP); Kazumine OGURA, Tokyo (JP); Koichi NIHEI, Tokyo (JP)

(73) Assignee: NEC Corporation, Tokyo (JP)

(21) Appl. No.: 19/332,361

(22) Filed: Sep. 18, 2025

(30) Foreign Application Priority Data
Sep. 30, 2024 (JP) 2024-170959

(51) Int. Cl. G08G 1/0967; G08G 1/052

(52) U.S. Cl. CPC G08G 1/096783; G08G 1/052; G08G 1/096725

(57) ABSTRACT

Provided is a road monitoring system including a fixed point observation sensing result acquisition unit for acquiring a fixed point observation sensing result of a fixed point observation sensing unit installed to sense a road, an abnormal area detection unit for detecting an abnormal area of the road based on the fixed point observation sensing result, and a request transmission unit for transmitting an abnormal area sensing request to a vehicle capable of sensing the abnormal area in a case where the abnormal area detection unit detects the abnormal area, in which the abnormal area sensing request includes a position of the abnormal area.

### INCORPORATION BY REFERENCE

This application is based upon and claims the benefit of priority from Japanese patent application No. 2024-170959, filed on Sep. 30, 2024, the disclosure of which is incorporated herein in its entirety by reference.

### TECHNICAL FIELD

The present disclosure relates to a road monitoring system, a vehicle, a road monitoring device, a road monitoring method, and a program.

### BACKGROUND ART

JP H10-091899 A discloses a road monitoring system that monitors a road using a monitoring camera installed on a side of the road and an in-vehicle camera mounted on a vehicle traveling on the road. Specifically, in a case where an obstacle is detected based on a monitoring image acquired from the monitoring camera, a vehicle closest to the obstacle is calculated based on a position of the obstacle and own vehicle positions of a plurality of vehicles passing near the obstacle, and an imaging command signal is output to the calculated vehicle. The in-vehicle camera images the obstacle upon receiving the imaging command signal.

Accordingly, since the obstacle is at a position relatively far from the monitoring camera, even in a case where a resolution sufficient for determining a size and a shape of the obstacle cannot be obtained, the size and the shape of the obstacle can be determined with high accuracy using a vehicle exterior image generated by the in-vehicle camera.

### SUMMARY

In a configuration of JP H10-091899 A, there is a possibility that the in-vehicle camera of the vehicle that received the imaging command signal fails to image the obstacle.

An example object of the present disclosure is to provide a technique for increasing a success rate of sensing by a vehicle.

According to an example aspect of the present disclosure, provided is a road monitoring system including
a fixed point observation sensing result acquisition means for acquiring a fixed point observation sensing result of a fixed point observation sensing means installed to sense a road,
an abnormal area detection means for detecting an abnormal area of the road based on the fixed point observation sensing result, and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

According to an example aspect of the present disclosure, provided is a road monitoring device including
a fixed point observation sensing result acquisition means for acquiring a fixed point observation sensing result of a fixed point observation sensing means installed to sense a road,
an abnormal area detection means for detecting an abnormal area of the road based on the fixed point observation sensing result, and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

According to an example aspect of the present disclosure, provided is a road monitoring method causing a computer to execute
acquiring a fixed point observation sensing result of a fixed point observation sensing means installed to sense a road,
detecting an abnormal area of the road based on the fixed point observation sensing result, and
transmitting an abnormal area sensing request to a vehicle capable of sensing the abnormal area in a case where the abnormal area is detected,
wherein the abnormal area sensing request includes a position of the abnormal area.

According to an example aspect of the present disclosure, provided is a program causing a computer to function as
a fixed point observation sensing result acquisition means for acquiring a fixed point observation sensing result of a fixed point observation sensing means installed to sense a road,
an abnormal area detection means for detecting an abnormal area of the road based on the fixed point observation sensing result, and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

According to the present disclosure, it is possible to increase a success rate of sensing by a vehicle.

### BRIEF DESCRIPTION OF DRAWINGS

FIG. 1 is a block diagram of a road monitoring system;

FIG. 2 is a control flow of the road monitoring system;

FIG. 3 is a schematic diagram of a road monitoring system;

FIG. 4 is a block diagram of a local processing device;

FIG. 5 is a block diagram of a road monitoring server;

FIG. 6 is a block diagram of a vehicle;

FIG. 7 is a control flow of the vehicle;

FIG. 8 is a control flow of the local processing device;

FIG. 9 is a control flow of the road monitoring server; and

FIG. 10 is a block diagram of a hardware configuration of a computer.

### EXAMPLE EMBODIMENT

### Overview of Present Disclosure

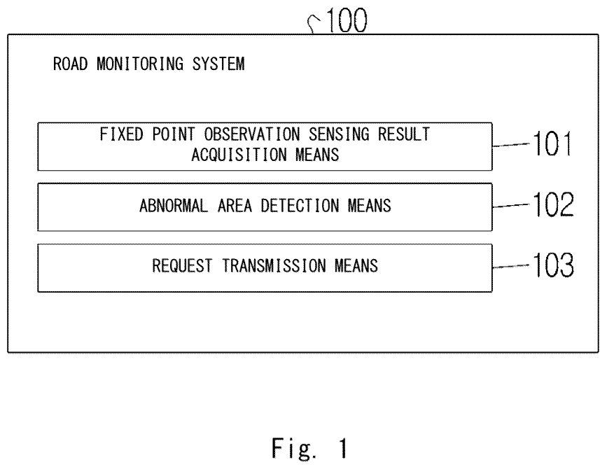

First, an overview of the present disclosure will be described. FIG. 1 is a block diagram of a road monitoring system 100. The road monitoring system 100 includes a fixed point observation sensing result acquisition means 101, an abnormal area detection means 102, and a request transmission means 103.

The fixed point observation sensing result acquisition means 101 acquires a fixed point observation sensing result of a fixed point observation sensing means installed to sense a road.

The abnormal area detection means 102 detects an abnormal area of the road based on the fixed point observation sensing result.

In a case where the abnormal area detection means 102 detects the abnormal area, the request transmission means 103 transmits an abnormal area sensing request to a vehicle capable of sensing the abnormal area.

The abnormal area sensing request includes a position of the abnormal area.

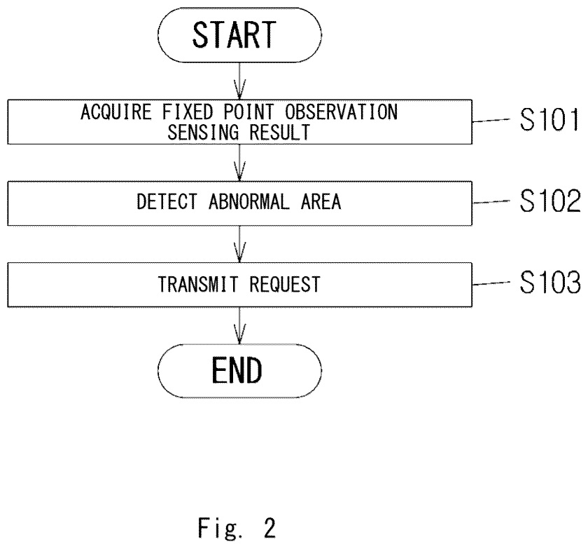

Next, an operation of the road monitoring system 100 will be described. FIG. 2 is a control flow of the road monitoring system.

First, the fixed point observation sensing result acquisition means 101 acquires the fixed point observation sensing result of the fixed point observation sensing means installed to sense the road (S101). Subsequently, the abnormal area detection means 102 detects the abnormal area of the road based on the fixed point observation sensing result (S102). In a case where the abnormal area detection means 102 detects the abnormal area, the abnormal area sensing request is transmitted to the vehicle capable of sensing the abnormal area (S103).

According to the above configuration, a success rate of sensing by the vehicle can be increased.

### First Example Embodiment

Next, a road monitoring system according to a first example embodiment of the present disclosure will be described.

Hereinafter, the present disclosure will be described according to the example embodiment of the disclosure, but the disclosure according to the claims is not limited to the following example embodiment. Not all the configurations described in the example embodiment are essential as means for solving the problem. To clarify description, in the following description and drawings, omission and simplification are made as appropriate. In the drawings, the same elements are denoted by the same reference numerals, and repeated description is omitted as necessary.

In the following example embodiments, the description will be divided into a plurality of sections or example embodiments as necessary for convenience, but unless otherwise mentioned, the sections or the embodiments are not irrelevant to each other, and one section or embodiment is in a relationship of a modified example, an application example, a detailed description, a supplementary description, or the like of a part or all of other sections or embodiments. In the following example embodiments, in a case of referring to the number of elements and the like (including a number, a numerical value, an amount, a range, and the like), the number is not limited to a specific number unless otherwise mentioned or clearly limited to the specific number in principle, and the number may be equal to or more than the specific number or may be equal to or less than the specific number.

In the following example embodiments, the components (including operation steps and the like) are not necessarily essential unless otherwise mentioned or considered to be obviously essential in principle. Similarly, in the following example embodiments, in a case where the shapes or the positional relationship of constituents, and the like are referred to, unless otherwise expressly stated or in cases where it is deemed, in principle, clearly not to be so, shapes and the like that are substantially approximate or similar to the described shape are understood to be included. The same applies to the above numbers (including a number, a numerical value, an amount, and a range).

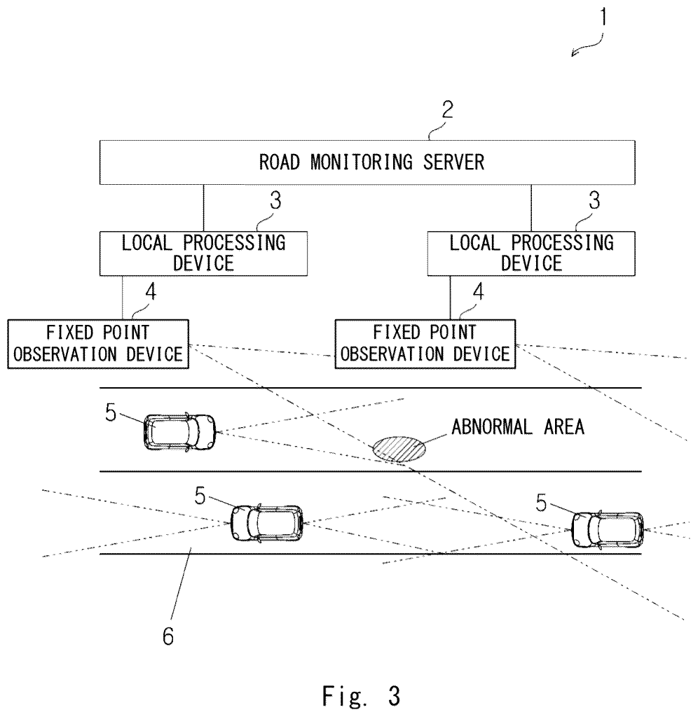

FIG. 3 is a schematic diagram of a road monitoring system 1. As illustrated in FIG. 3, the road monitoring system 1 includes a road monitoring server 2, a plurality of local processing devices 3, a plurality of fixed point observation devices 4, and a plurality of vehicles 5.

Typically, the road monitoring server 2 and the plurality of local processing devices 3 perform bidirectional communication via a wide area network (WAN) such as the Internet. Each of the local processing devices 3 is fixedly installed on the side of or above a road 6. Typically, each of the local processing devices 3 performs bidirectional communication with one or a plurality of vehicles 5 traveling or stopping near the local processing device 3 via dedicated short range communication (DSRC). Typically, the road monitoring server 2 performs bidirectional communication with the plurality of vehicles 5 via the wide area network (WAN).

The road monitoring system 1 includes at least the road monitoring server 2 and the plurality of local processing devices 3. The road monitoring server 2 and the plurality of local processing devices 3 cooperate with each other to configure the road monitoring system 1. In the present example embodiment, the road monitoring system 1 is implemented by distributed processing between a plurality of devices. Typically, the plurality of devices are the road monitoring server 2 and the plurality of local processing devices 3. However, the road monitoring system 1 may be implemented by one single device. For example, each of the local processing devices 3 may implement a part or all of the functions of the road monitoring server 2.

Typically, the plurality of local processing devices 3 and the plurality of fixed point observation devices 4 are arranged on a one-to-one basis. Each of the local processing devices 3 and each of the fixed point observation devices 4 are typically wired and connected.

Each of the fixed point observation devices 4 is a specific example of the fixed point observation sensing means installed to sense the road 6. In the present example embodiment, each of the fixed point observation devices 4 is a light detection and ranging (LiDAR) device. Each of the fixed point observation devices 4 generates a three-dimensional point cloud by measuring a distance of a space including a road surface of the road 6, and outputs the generated three-dimensional point cloud to the relevant local processing device 3 as the fixed point observation sensing result. Instead, each of the fixed point observation devices 4 may be a radio detection and ranging (Radar) device or a stereo camera. Here, each of the fixed point observation devices 4 generates the three-dimensional point cloud by measuring the distance of the space including the road surface of the road 6, and outputs the generated three-dimensional point cloud to the relevant local processing device 3 as the fixed point observation sensing result. Each of the fixed point observation devices 4 may be an image capturing apparatus. Here, each of the fixed point observation devices 4 generates a two-dimensional image by capturing an image of the space including the road surface of the road 6, and outputs the generated two-dimensional image to the relevant local processing device 3 as the fixed point observation sensing result.

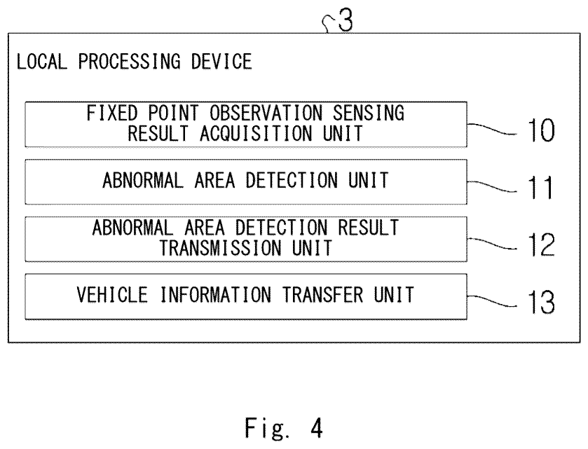

FIG. 4 is a block diagram of the local processing device 3. As illustrated in FIG. 4, the local processing device 3 includes a fixed point observation sensing result acquisition unit 10, an abnormal area detection unit 11, an abnormal area detection result transmission unit 12, and a vehicle information transfer unit 13.

The fixed point observation sensing result acquisition unit 10 acquires the fixed point observation sensing result from the relevant fixed point observation device 4.

The abnormal area detection unit 11 detects the abnormal area of the road 6 based on the fixed point observation sensing result.

Specifically, in a case where the fixed point observation sensing result is the three-dimensional point cloud, the abnormal area detection unit 11 typically detects foreign matters present on the road surface of the road 6 as the abnormal area using PointNet. In a case where the fixed point observation sensing result is the three-dimensional point cloud, the abnormal area detection unit 11 may detect the foreign matters present on the road surface of the road 6 as the abnormal area by detecting the road surface of the road 6 and detecting a point cloud deviated upward from the road surface by a distance equal to or more than a predetermined distance. In a case where the fixed point observation sensing result is the two-dimensional image, the abnormal area detection unit 11 typically detects the foreign matters present on the road surface of the road 6 as the abnormal area using faster region-based convolutional neural networks (Faster R-CNN), you only look once (YOLO), or single shot multibox detector (SSD). In addition to detecting the foreign matters present on the road surface of the road 6 as the abnormal area, the abnormal area detection unit 11 may detect a depression or a protrusion of the road surface of the road 6 as the abnormal area. The abnormal area detection unit 11 generates the abnormal area detection result for each of the detected abnormal areas.

Upon detecting the abnormal area of the road 6, the abnormal area detection unit 11 acquires a detection score for each class output to an output layer of a neural network. Then, in a case where the detection score exceeds a predetermined threshold, the abnormal area detection unit 11 detects the abnormal area classified into the class relevant to the detection score. The position of the abnormal area is typically expressed in a geographic coordinate system. The abnormal area detection result typically includes the class of the relevant abnormal area, the detection score of the relevant abnormal area, and the position of the relevant abnormal area.

The abnormal area detection result transmission unit 12 transmits the abnormal area detection result generated by the abnormal area detection unit 11 to the road monitoring server 2.

The vehicle information transfer unit 13 acquires vehicle information from one or a plurality of vehicles 5 traveling or stopping in a range communicable with the local processing device 3 via DSRC, and transmits the acquired vehicle information to the road monitoring server 2.

The vehicle information includes a position, a traveling speed, a traveling direction, a sensing range, and other types of vehicle-related information on the relevant vehicle 5. The position of the vehicle 5 is typically expressed in a geographic coordinate system. The sensing range is typically expressed by a plane angle based on a forward direction of the vehicle 5 in a plan view.

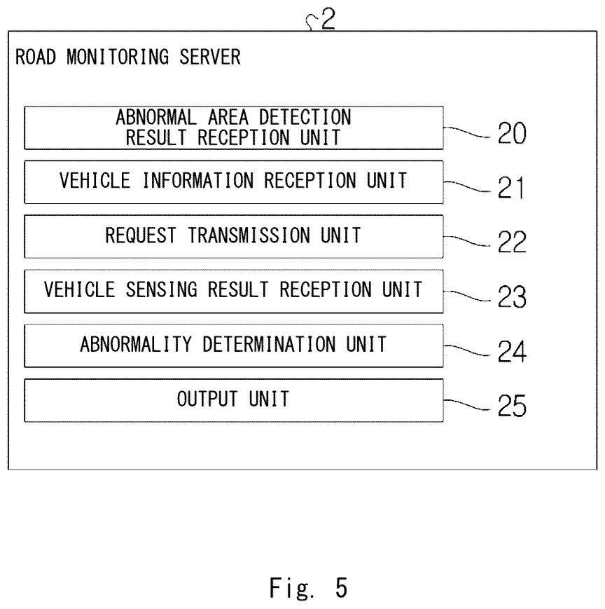

FIG. 5 is a block diagram of the road monitoring server 2. As illustrated in FIG. 5, the road monitoring server 2 includes an abnormal area detection result reception unit 20, a vehicle information reception unit 21, a request transmission unit 22, a vehicle sensing result reception unit 23, an abnormality determination unit 24, and an output unit 25.

The abnormal area detection result reception unit 20 receives the abnormal area detection result from each of the local processing devices 3.

The vehicle information reception unit 21 receives the vehicle information from each of the local processing devices 3. The vehicle information reception unit 21 may directly receive the vehicle information from each of the vehicles 5 without passing each of the local processing devices 3.

In a case where the abnormal area detection result reception unit 20 receives the abnormal area detection result, the request transmission unit 22 transmits the abnormal area sensing request to the vehicle 5 capable of sensing the abnormal area relevant to the abnormal area detection result.

Specifically, the request transmission unit 22 identifies the vehicle 5 capable of sensing the abnormal area based on the vehicle information. For example, the request transmission unit 22 identifies the vehicle 5 of which a sensing range includes the abnormal area now or in the future based on the vehicle information of the plurality of vehicles 5 traveling or stopping near the abnormal area. In a case where a plurality of vehicles 5 are identified as the vehicles 5 of which the sensing range includes the abnormal area now or in the future, the request transmission unit 22 may further identify the vehicle 5 capable of sensing the abnormal area at a shortest distance. The request transmission unit 22 may regard the vehicle 5 traveling or stopping near the abnormal area as the vehicle capable of sensing the abnormal area.

The abnormal area sensing request instructs the vehicle 5 that receives the transmission to sense the abnormal area and transmit a vehicle sensing result that is the sensing result to the road monitoring server 2. In the present example embodiment, the abnormal area sensing request includes the position of the abnormal area. Accordingly, the vehicle 5 can sense the abnormal area at an appropriate timing. The abnormal area sensing request may include a sensing timing at which the vehicle 5 that receives the transmission senses the abnormal area. Accordingly, the vehicle 5 can sense the abnormal area at an appropriate timing. Here, the request transmission unit 22 can typically generate the sensing timing based on the position of the abnormal area and the position and the traveling speed, the traveling direction, and the sensing range of the vehicle 5 that receives the transmission.

The vehicle sensing result reception unit 23 receives the vehicle sensing result from the vehicle 5. Similarly to the fixed point observation sensing result, the vehicle sensing result is the three-dimensional point cloud or the two-dimensional image.

The abnormality determination unit 24 determines a degree of abnormality of the abnormal area based on the vehicle sensing result. The degree of abnormality is evaluated in five stages as an example. The abnormality determination unit 24 may generate integrated sensing information by performing sensor fusion on the fixed point observation sensing result and the vehicle sensing result, and determine the degree of abnormality of the abnormal area based on the integrated sensing information. For example, the abnormality determination unit 24 can determine sizes, types, materials, and the like of the foreign matters present in the abnormal area based on the vehicle sensing result, and determine the degree of abnormality of the abnormal area based on the determination result. Here, the abnormality determination unit 24 may use an object detection technology such as the above-described PointNet, Faster R-CNN, YOLO, or SSD.

The output unit 25 outputs an abnormality avoidance command to the one or a plurality of vehicles 5 traveling near the abnormal area based on the determination result by the abnormality determination unit 24. Specifically, the output unit 25 determines whether to output the abnormality avoidance command according to a result of comparing the degree of abnormality of the abnormal area with a preset threshold. Typically, the abnormality avoidance command includes the position of the abnormal area. The abnormality avoidance command may further include the class of the abnormal area. Note that the output unit 25 may notify an administrator of the road 6 in addition to outputting the abnormality avoidance command to the one or a plurality of vehicles 5 traveling near the abnormal area.

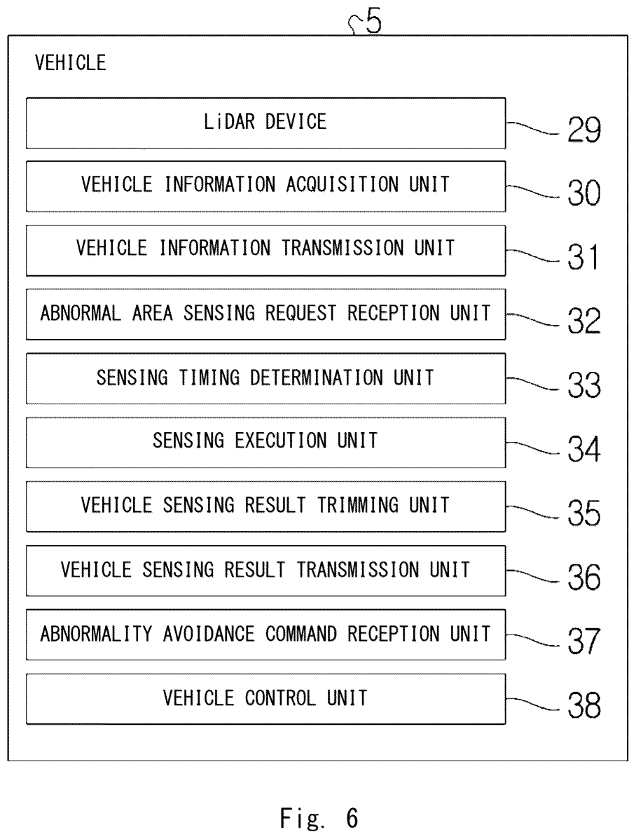

FIG. 6 is a block diagram of the vehicle 5. As illustrated in FIG. 6, the vehicle 5 includes a LiDAR device 29, a vehicle information acquisition unit 30, a vehicle information transmission unit 31, an abnormal area sensing request reception unit 32, a sensing timing determination unit 33, a sensing execution unit 34, a vehicle sensing result trimming unit 35, a vehicle sensing result transmission unit 36, an abnormality avoidance command reception unit 37, and a vehicle control unit 38.

The LiDAR device 29 typically measures a distance of a front space of the vehicle 5 and generates the three-dimensional point cloud. The LiDAR device 29 may further measure a distance of a rear space or a side space of the vehicle 5 and generate the three-dimensional point cloud. In the vehicle 5, a Radar device or a stereo camera may be mounted as a device that generates the three-dimensional point cloud instead of the LiDAR device 29. In the vehicle 5, an image capturing apparatus that captures an image of the front space of the vehicle 5 and generates the two-dimensional image may be mounted instead of the LiDAR device 29. Here, the image capturing apparatus may further capture an image of the rear space or the side space of the vehicle 5 and generate the two-dimensional image.

The vehicle information acquisition unit 30 acquires the vehicle information. As described above, the vehicle information includes the position, the traveling speed, the traveling direction, the sensing range, and other types of vehicle-related information on the vehicle 5. The vehicle information acquisition unit 30 acquires the position of the vehicle 5 using a global navigation satellite system (GNSS) module as an example of an own position estimation means. The GNSS module typically includes a global positioning system (GPS) module, a global navigation satellite system (GLONASS) module, a Galileo module, a BeiDou module, and a quasi-zenith satellite system (QZSS) module. As another example of the own position estimation means, the vehicle information acquisition unit 30 may acquire the position of the vehicle 5 using simultaneous localization and mapping (SLAM).

The vehicle information transmission unit 31 transmits the vehicle information acquired by the vehicle information acquisition unit 30 to the local processing device 3.

The abnormal area sensing request reception unit 32 receives the abnormal area sensing request from the road monitoring server 2.

In a case where the abnormal area sensing request does not include the sensing timing, the sensing timing determination unit 33 determines the sensing timing at which the vehicle 5 senses the abnormal area. Specifically, the sensing timing determination unit 33 determines the sensing timing based on the position, the traveling speed, the traveling direction, and the sensing range of the vehicle 5 and the position of the abnormal area included in the abnormal area sensing request.

The sensing execution unit 34 executes sensing of the abnormal area using the LiDAR device 29 according to the sensing timing included in the abnormal area sensing request or the sensing timing determined by the sensing timing determination unit 33. Accordingly, the sensing execution unit 34 acquires the three-dimensional point cloud generated by the LiDAR device 29. The three-dimensional point cloud generated by the LiDAR device 29 is a specific example of the vehicle sensing result or the sensing result. Coordinates of the three-dimensional point cloud generated by the LiDAR device 29 are expressed in a LiDAR coordinate system that is a coordinate system unique to the LiDAR device 29. Thus, the sensing execution unit 34 executes coordinate transformation on the coordinates of the three-dimensional point cloud expressed in the LiDAR coordinate system into a geographic coordinate system based on the position, the traveling speed, the traveling direction, and the sensing range of the vehicle 5.

The vehicle sensing result trimming unit 35 is a specific example of a trimming means that trims the vehicle sensing result. Specifically, in a case where the vehicle sensing result is the three-dimensional point cloud, the vehicle sensing result trimming unit 35 spatially trims the vehicle sensing result in such a way as to leave a point cloud of the abnormal area and remove a point cloud of other portions. For example, the vehicle sensing result trimming unit 35 may trim the vehicle sensing result in such a way as to leave an inside point cloud and remove an outside point cloud with respect to a spherical surface having a predetermined radius centering on the position of the abnormal area from the three-dimensional point cloud that is the vehicle sensing result. For example, the vehicle sensing result trimming unit 35 may trim the vehicle sensing result in such a way as to detect the abnormal area of the road 6 using the above-described PointNet, leave the three-dimensional point cloud relevant to the abnormal area, and remove other three-dimensional point clouds. Therefore, the vehicle sensing result trimming unit 35 is a specific example of an abnormal area detection means for detecting the abnormal area based on the three-dimensional point cloud.

In a case where the image capturing apparatus is mounted in the vehicle 5 instead of the LiDAR device 29, that is, in a case where the vehicle sensing result is a plurality of frames of two-dimensional images, the vehicle sensing result trimming unit 35 may spatially trim the vehicle sensing result in such a way as to leave the abnormal area and remove the other portions. The vehicle sensing result trimming unit 35 may trim the vehicle sensing result on a time axis in such a way as to extract a frame in which the abnormal area is most clearly shown among the plurality of frames.

The vehicle sensing result transmission unit 36 transmits the vehicle sensing result to the road monitoring server 2.

The abnormality avoidance command reception unit 37 receives the abnormality avoidance command from the road monitoring server 2.

In a case where the abnormality avoidance command reception unit 37 receives the abnormality avoidance command from the road monitoring server 2, the vehicle control unit 38 controls the traveling of the vehicle 5 in such a way as to avoid the abnormal area based on the position of the abnormal area indicated by the abnormality avoidance command. Control of the traveling of the vehicle 5 in such a way as to avoid the abnormal area includes, for example, steering of the vehicle 5, acceleration and deceleration of the vehicle 5, and other types of control of the vehicle 5.

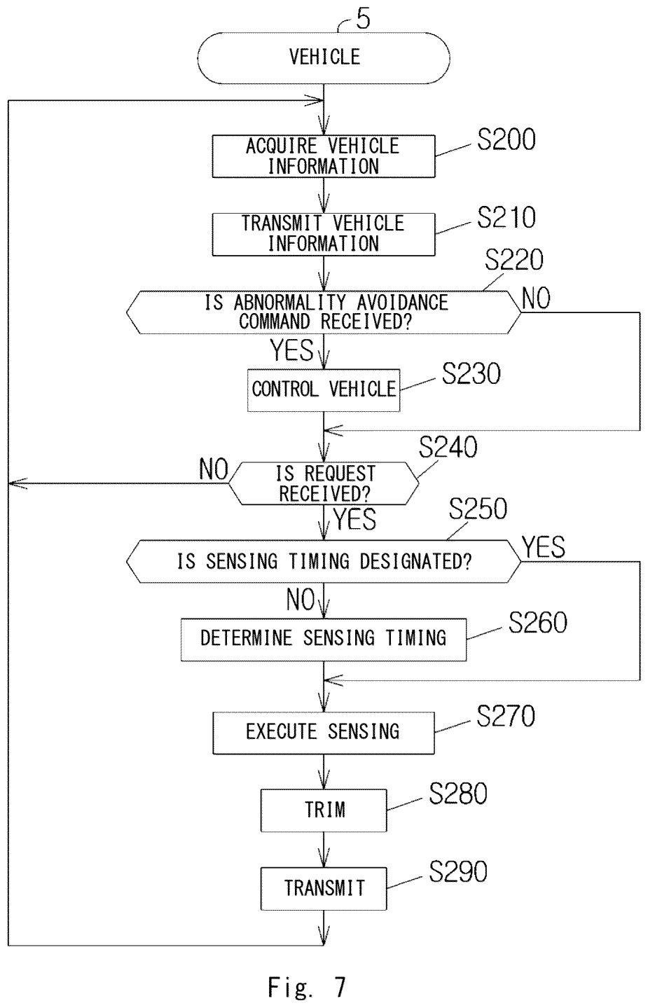

Next, an operation of the vehicle 5 will be described with reference to FIG. 7. FIG. 7 illustrates a control flow of the vehicle 5.

First, the vehicle information acquisition unit 30 acquires the vehicle information (S200). Subsequently, the vehicle information transmission unit 31 transmits the vehicle information acquired by the vehicle information acquisition unit 30 to the local processing device 3 (S210). Subsequently, the abnormality avoidance command reception unit 37 determines whether the abnormality avoidance command is received from the road monitoring server 2 (S220). In a case where the abnormality avoidance command is not received from the road monitoring server 2 (S220: NO), the abnormal area sensing request reception unit 32 proceeds the processing to step S240. Conversely, in a case where the abnormality avoidance command is received from the road monitoring server 2 (S220: YES), the abnormal area sensing request reception unit 32 proceeds the processing to step S230. Subsequently, the vehicle control unit 38 controls the traveling of vehicle 5 in such a way as to avoid the abnormal area (S230).

Subsequently, the abnormal area sensing request reception unit 32 determines whether the abnormal area sensing request is received from the road monitoring server 2 (S240). In a case where the abnormal area sensing request is not received from the road monitoring server 2 (S240: NO), the abnormal area sensing request reception unit 32 returns the processing to step S200. Conversely, in a case where the abnormal area sensing request is received from the road monitoring server 2 (S240: YES), the abnormal area sensing request reception unit 32 proceeds the processing to step S250.

The sensing timing determination unit 33 determines whether the abnormal area sensing request includes the sensing timing (S250). In a case where the abnormal area sensing request does not include the sensing timing (S250: NO), the sensing timing determination unit 33 determines the sensing timing (S260) and proceeds the processing to step S270. Conversely, in a case where the abnormal area sensing request includes the sensing timing (S250: YES), the sensing timing determination unit 33 proceeds the processing to step S270.

Subsequently, the sensing execution unit 34 executes sensing of the abnormal area using the LiDAR device 29 according to the sensing timing included in the abnormal area sensing request or the sensing timing determined by the sensing timing determination unit 33 (S270). Subsequently, the vehicle sensing result trimming unit 35 trims the three-dimensional point cloud that is the vehicle sensing result in such a way as to leave the abnormal area and remove the other portions (S280). Then, the vehicle sensing result transmission unit 36 transmits the trimmed three-dimensional point cloud to the road monitoring server 2 as the vehicle sensing result (S290), and returns the processing to step S200.

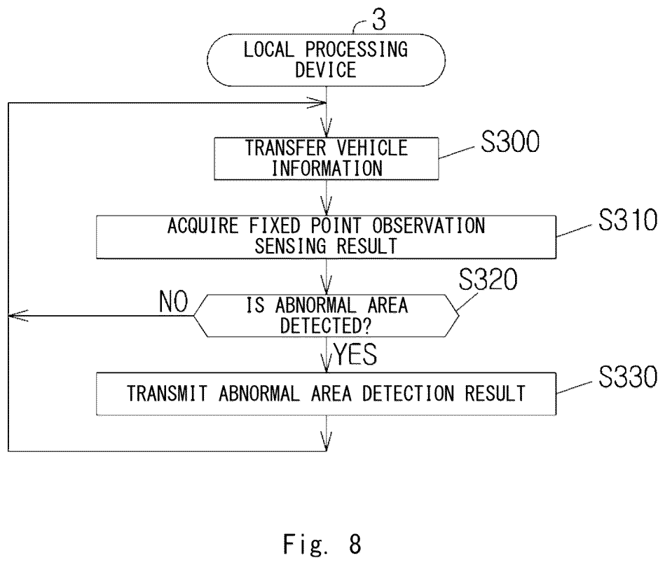

Next, an operation of the local processing device 3 will be described with reference to FIG. 8. FIG. 8 is a control flow of the local processing device 3.

First, the vehicle information transfer unit 13 acquires the vehicle information from the one or a plurality of vehicles 5 traveling in a range communicable with the local processing device 3 via the DSRC, and transmits the acquired vehicle information to the road monitoring server 2 (S300). Subsequently, the fixed point observation sensing result acquisition unit 10 acquires the fixed point observation sensing result from the relevant fixed point observation device 4 (S310). Subsequently, the abnormal area detection unit 11 detects the abnormal area of the road 6 based on the fixed point observation sensing result (S320). In a case where the abnormal area of the road 6 is not detected based on the fixed point observation sensing result (S320: NO), the abnormal area detection unit 11 returns the processing to step S300. Conversely, in a case where an abnormal area of the road 6 is detected based on the fixed point observation sensing result (S320: YES), the abnormal area detection unit 11 proceeds the processing to step S330. Subsequently, the abnormal area detection result transmission unit 12 transmits the abnormal area detection result generated by the abnormal area detection unit 11 to the road monitoring server 2 (S330), and returns the processing to step S300.

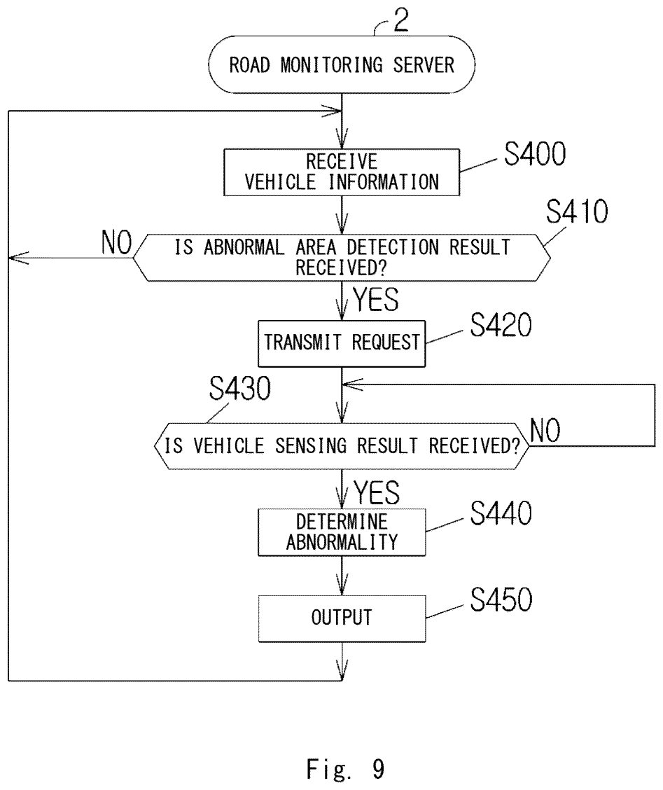

Next, an operation of the road monitoring server 2 will be described with reference to FIG. 9. FIG. 9 is a control flow of the road monitoring server 2.

First, the vehicle information reception unit 21 receives the vehicle information from each of the local processing devices 3 (S400). Subsequently, the abnormal area detection result reception unit 20 receives the abnormal area detection result from each of the local processing devices 3 (S410). In a case where the abnormal area detection result is not received from each of the local processing devices 3 (S410: NO), the abnormal area detection result reception unit 20 returns the processing to step S400. Conversely, in a case where the abnormal area detection result is received from each of the local processing devices 3 (S410: YES), the abnormal area detection result reception unit 20 proceeds the processing to step S420. Subsequently, the request transmission unit 22 transmits the abnormal area sensing request to the vehicle 5 capable of sensing the abnormal area relevant to the abnormal area detection result (S420). Subsequently, the vehicle sensing result reception unit 23 waits until the vehicle sensing result is received from the vehicle 5 (S430: NO), and in a case where the vehicle sensing result is received (S430: YES), proceeds the processing to step S440. Subsequently, the abnormality determination unit 24 determines the degree of abnormality of the abnormal area based on the vehicle sensing result (S440). Then, the output unit 25 outputs the abnormality avoidance command to the one or a plurality of vehicles 5 traveling near the abnormal area based on the determination result by the abnormality determination unit 24 (S450), and returns the processing to step S400.

The first example embodiment of the present disclosure has been described above. The first example embodiment has the following features.

The local processing device 3 includes the fixed point observation sensing result acquisition unit 10 (fixed point observation sensing result acquisition means) that acquires the fixed point observation sensing result of the fixed point observation device 4 (fixed point observation sensing means) installed to sense the road 6. The local processing device 3 includes the abnormal area detection unit 11 (abnormal area detection means) that detects the abnormal area of the road 6 based on the fixed point observation sensing result. The road monitoring server 2 includes the request transmission unit 22 (request transmission means) that transmits the abnormal area sensing request to the vehicle 5 capable of sensing the abnormal area in a case where the abnormal area detection unit 11 detects the abnormal area. The abnormal area sensing request includes the position of the abnormal area. According to the above configuration, a success rate of sensing by the vehicle 5 can be increased.

The abnormal area sensing request includes the sensing timing at which the vehicle 5 senses the abnormal area. According to the above configuration, the vehicle 5 can sense the abnormal area at an appropriate timing.

The request transmission unit 22 determines the sensing timing based on the position of the abnormal area and the position and the traveling speed of the vehicle 5. According to the above configuration, the sensing timing appropriate for sensing the abnormal area can be determined.

The road monitoring server 2 further includes the vehicle sensing result reception unit 23 (vehicle sensing result reception means) that receives the vehicle sensing result from the vehicle 5. According to the above configuration, the abnormal area can be evaluated using the vehicle sensing result.

The vehicle sensing result is trimmed in such a way as to leave the abnormal area. According to the above configuration, an amount of communication between the road monitoring server 2 and the vehicle 5 can be reduced.

The vehicle 5 also includes the sensing timing determination unit 33 (sensing timing determination means) that determines the sensing timing at which the abnormal area is sensed based on the position of the abnormal area and the position and the traveling speed of the vehicle 5. According to the above configuration, the abnormal area can be sensed at an appropriate timing.

The vehicle 5 includes the vehicle sensing result trimming unit 35 (trimming means) that detects the abnormal area based on the vehicle sensing result (sensing result) and performs trimming in such a way as to leave the abnormal area. According to the above configuration, the amount of communication between the road monitoring server 2 and the vehicle 5 can be reduced.

The first example embodiment can be modified as follows, for example. That is, in a case where a notification of detection of foreign matters is received from the vehicle 5, the abnormal area detection unit 11 may slightly excessively detect the abnormal area by lowering a threshold of the detection score used for detecting the abnormal area.

The request transmission unit 22 may assign an ID to each of the abnormal areas detected by the abnormal area detection unit 11, and may not transmit the abnormal area sensing request to the vehicle 5 for the abnormal area having a relatively low degree of abnormality.

The threshold of the detection score used by the abnormal area detection unit 11 to detect the abnormal area may be changed based on the determination result by the abnormality determination unit 24. For example, in a case where the degree of abnormality of the abnormal area is not appropriate for outputting the abnormality avoidance command in 80% of the determination result by the abnormality determination unit 24, it is conceivable that the abnormal area detection unit 11 excessively detects the abnormal area, and thus, it is conceivable to lower the threshold of the detection score used by the abnormal area detection unit 11 to detect the abnormal area.

### Example of Hardware Configuration

Hereinafter, a case where each functional component of each of the devices such as the road monitoring server 2, the local processing device 3, and the vehicle 5 is implemented in combination of hardware and software will be described.

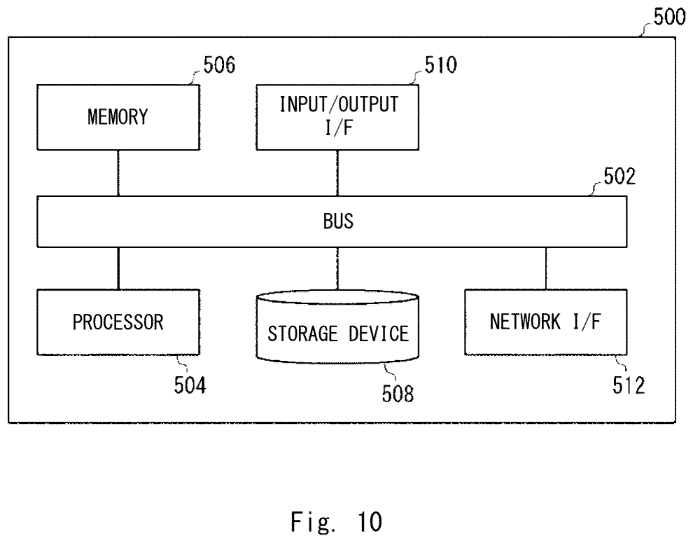

FIG. 10 is a block diagram illustrating a hardware configuration of a computer. The device according to the present disclosure can implement the above-described functions by a computer 500 that has the hardware configuration illustrated in FIG. 10. The computer 500 may be a portable computer such as a smartphone or a tablet terminal, or may be a stationary computer such as a PC. The computer 500 may be a dedicated computer designed to implement each of the devices, or a general-purpose computer. The computer 500 can implement a relevant function by installing a predetermined program.

The computer 500 includes a bus 502, a processor 504, a memory 506, a storage device 508, an input/output interface 510 (an interface is also referred to as an interface (I/F)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is any of various processors such as a CPU, a GPU, and an FPGA. The memory 506 is a primary storage device achieved by using a random access memory (RAM) or the like.

The storage device 508 is an auxiliary storage device implemented using a hard disk, an SSD, a memory card, a read only memory (ROM), or the like. The storage device 508 stores a program for implementing a predetermined function. The processor 504 reads the program into the memory 506 and executes the program to achieve each functional component of each of the devices.

The input/output interface 510 is an interface for connecting the computer 500 and an input/output device. For example, an input device such as a keyboard and an output device such as a display device are connected to the input/output interface 510.

The network interface 512 is an interface for connecting the computer 500 to a network.

Although the example of the hardware configuration in the disclosure has been described above, the above-described example embodiments are not limited here. The disclosure can also be implemented by causing a processor to execute a computer program.

In the above-described example, the program includes instructions (or software codes) for causing a computer to perform one or a plurality of functions described in the example embodiments in a case of being read by the computer. The program may be stored in a non-transitory computer-readable medium or a tangible storage medium. As an example and not by way of limitation, computer-readable media or tangible storage media include a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disk storages, a magnetic cassette, a magnetic tape, and a magnetic disk storage or other magnetic storage devices. The program may be transmitted on a transitory computer-readable medium or communication medium. As an example and not by way of limitation, transitory computer-readable media or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Each of the drawings is merely an example to illustrate one or a plurality of example embodiments. Each of the drawings is not associated with only one specific example embodiment, but may be associated with one or a plurality of other example embodiments. As those skilled in the art will appreciate, various features or steps described with reference to any one of the drawings may be combined with features or steps illustrated in one or a plurality of other drawings, for example, to create an example embodiment that is not explicitly illustrated or described. All of the features or the steps illustrated in any one of the drawings for describing illustrative example embodiments are not necessarily essential, and a part of the features or the steps may be omitted. The order of the steps described in any of the drawings may be changed as appropriate.

A part or all of the above example embodiments may also be described as the following Supplementary Notes, but are not limited to the following.

### (Supplementary Note 1)

A road monitoring system including:
a fixed point observation sensing result acquisition means for acquiring a fixed point observation sensing result of a fixed point observation sensing means installed to sense a road;
an abnormal area detection means for detecting an abnormal area of the road based on the fixed point observation sensing result; and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

### (Supplementary Note 2)

The road monitoring system according to Supplementary Note 1, wherein the abnormal area sensing request includes a sensing timing at which the vehicle senses the abnormal area.

### (Supplementary Note 3)

The road monitoring system according to Supplementary Note 2, wherein the request transmission means determines the sensing timing based on a position of the abnormal area and a position and a traveling speed of the vehicle.

### (Supplementary Note 4)

The road monitoring system according to Supplementary Note 1, further including a vehicle sensing result reception means for receiving a vehicle sensing result from the vehicle.

### (Supplementary Note 5)

The road monitoring system according to Supplementary Note 4, wherein the vehicle sensing result is trimmed in such a way as to leave the abnormal area.

### (Supplementary Note 6)

The vehicle according to Supplementary Note 1, further including a sensing timing determination means for determining a sensing timing at which the abnormal area is sensed based on a position of the abnormal area and a position and a traveling speed of the vehicle.

### (Supplementary Note 7)

The vehicle according to Supplementary Note 1, further including a trimming means for detecting the abnormal area based on a sensing result and trimming the sensing result in such a way as to leave the abnormal area.

### (Supplementary Note 8)

A road monitoring device including:
a fixed point observation sensing result acquisition means for acquiring a fixed point observation sensing result of a fixed point observation sensing means installed to sense a road;
an abnormal area detection means for detecting an abnormal area of the road based on the fixed point observation sensing result; and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

### (Supplementary Note 9)

A road monitoring method causing a computer to execute:
acquiring a fixed point observation sensing result of a fixed point observation sensing means installed to sense a road;
detecting an abnormal area of the road based on the fixed point observation sensing result; and
transmitting an abnormal area sensing request to a vehicle capable of sensing the abnormal area in a case where the abnormal area is detected,
wherein the abnormal area sensing request includes a position of the abnormal area.

### (Supplementary Note 10)

A program causing a computer to function as:
a fixed point observation sensing result acquisition means for acquiring a fixed point observation sensing result of a fixed point observation sensing means installed to sense a road;
an abnormal area detection means for detecting an abnormal area of the road based on the fixed point observation sensing result; and
a request transmission means for transmitting an abnormal area sensing request to a vehicle capable of sensing the abnormal area in a case where the abnormal area detection means detects the abnormal area,
wherein the abnormal area sensing request includes a position of the abnormal area.

A part or all of the elements (for example, configurations and functions) described in Supplementary Notes 2 to 7 dependent on Supplementary Note 1 can also depend on Supplementary Notes 8 to 10 in the same dependency relationship as that of Supplementary Notes 2 to 7. A part or all of the elements described in any Supplementary Note may be applied to various types of hardware, software, recording means for recording software, systems, and methods.

1. A road monitoring system comprising:
at least one memory storing computer-executable instructions; and
at least one processor configured to access the at least one memory and execute the computer-executable instructions to:
acquire a fixed point observation sensing result of a fixed point observation sensing device installed to sense a road;
detect an abnormal area of the road based on the fixed point observation sensing result; and
transmit an abnormal area sensing request to a vehicle capable of sensing the abnormal area in a case where the abnormal area is detected,
wherein the abnormal area sensing request includes a position of the abnormal area.

2. The road monitoring system according to claim 1, wherein the abnormal area sensing request includes a sensing timing at which the vehicle senses the abnormal area.

3. The road monitoring system according to claim 2, wherein the at least one processor is further configured to execute the instructions to determine the sensing timing based on a position of the abnormal area and a position and a traveling speed of the vehicle.

4. The road monitoring system according to claim 1, wherein the at least one processor is further configured to execute the instructions to receive a vehicle sensing result from the vehicle.

5. The road monitoring system according to claim 4, wherein the vehicle sensing result is trimmed in such a way as to leave the abnormal area.

6. The vehicle according to claim 1, further comprising a sensing timing determination means for determining a sensing timing at which the abnormal area is sensed based on a position of the abnormal area and a position and a traveling speed of the vehicle.

7. The vehicle according to claim 1, comprising:
at least one memory storing computer-executable instructions; and
at least one processor configured to access the at least one memory and execute the computer-executable instructions to detect the abnormal area based on a sensing result and trim the sensing result in such a way as to leave the abnormal area.

8. A road monitoring device comprising:
at least one memory storing computer-executable instructions; and
at least one processor configured to access the at least one memory and execute the computer-executable instructions to:
acquire a fixed point observation sensing result of a fixed point observation sensing device installed to sense a road;
detect an abnormal area of the road based on the fixed point observation sensing result; and
transmit an abnormal area sensing request to a vehicle capable of sensing the abnormal area in a case where the abnormal area is detected,
wherein the abnormal area sensing request includes a position of the abnormal area.

9. A computer-implemented road monitoring method being performed by at least one processor executing stored instructions to perform steps comprising:
acquiring a fixed point observation sensing result of a fixed point observation sensing device installed to sense a road;
detecting an abnormal area of the road based on the fixed point observation sensing result; and
transmitting an abnormal area sensing request to a vehicle capable of sensing the abnormal area in a case where the abnormal area is detected,
wherein the abnormal area sensing request includes a position of the abnormal area.
